(19) United States
(12) Patent Application Publication
(10) Pub. No.: US 2024/0428220 A1
(43) Pub. Date: Dec. 26, 2024

(54) SYSTEMS AND METHODS FOR A CREDIT-BASED SPLIT-COMMISSION ELECTRONIC PAYMENT NETWORK

(71) Applicant: Paybook, Inc., Austin, TX (US)

(72) Inventor: Gerardo Trevino Rojas, Lake Hills, TX (US)

(21) Appl. No.: 18/553,528

(22) PCT Filed: Aug. 17, 2021
(86) PCT No.: PCT/US2021/046356

§ 371 Date: Aug. 14, 2024

Related U.S. Application Data
(60) Provisional application No. 63/168,228, filed on Mar. 30, 2021.

(51) Int. Cl. G06Q 20/24; G06Q 20/10; G06Q 20/40; H04L 67/306

(52) U.S. Cl. CPC G06Q 20/24; G06Q 20/10; G06Q 20/401; H04L 67/306

(57) ABSTRACT

Techniques are described for conducting an electronic transaction using a split-commission payment service. Techniques can include using currency-based credits, wherein credits are also provided as commissions to a referrer of the payor and a previous payee of the payor. The techniques can include one or more of a payment service providing a payment application to a user device of a user, causing a financial account to be opened on a user's behalf at a financial institution affiliated with the payment service, transferring funds from a funding source of a user to the financial account, associating a user profile of a user with credits equivalent to a balance of the financial account, receiving transaction data for a transaction, determining a payee fee for the transaction, transferring currency or credits equivalent to the transaction amount from payor to payee, splitting the payee fee between at least the payment service, referring user, and previous payee, and distributing currency or credits accordingly.

### RELATED APPLICATIONS

This PCT application claims priority from U.S. Provisional Patent Application No. 63/168,228, filed Mar. 30, 2021, which is incorporated herein by reference.

### BACKGROUND

Credit card and debit card transactions have traditionally come at a cost to merchants. That cost can be some combination of interchange fees, assessment fees, service fees, and a payment processor's markup. In these traditional systems, the merchant bears the cost of the convenience that the customer enjoys by paying with a payment card.

Conventionally, the merchant fee in a payment card transaction is a percentage of the transaction amount plus a flat fee, together often totaling around 2% of the transaction amount. There can be a number of components of the merchant fee, which can be paid to different entities necessary in processing and settlement of the payment. The largest percentage of the merchant fee is often the interchange fee, which is paid to the issuer of the customer's payment card, and the assessment fees, which can be paid to the payment card network. A percentage is often also paid to the payment processor. Thus, processing payment card transactions conventionally requires participation of multiple entities beyond the merchant and customer and payment of multiple fees.

Further, while digital payments can be performed using peer-to-peer technology, often at a lower cost per transaction to the payee than payment card transactions, traditional peer-to-peer payment processors limit the total amount that any one user can pay (or be paid) in a period of time. Additionally, in conventional peer-to-peer systems, it can take days for funds to be transferred to a payee's bank account. This makes digital payments an inadequate solution for many transactions.

There is a need for a payment network that minimizes the cost to payees to accept payments, minimizes the number of entities involved in processing a transaction, minimizes the time to transfer funds from payor to payee, and minimizes the number of funds transfers so as to minimize processing resources. There is also a need to incentivize participation in an electronic payment system.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example system for conducting a split commission transaction within a community payment network, as described herein.

FIG. 2 is a flow diagram illustrating an example process for enrolling a new user with a community payment network, as described herein.

FIGS. 3A and 3B are a flow diagram illustrating an example process for conducting a split-commission transaction in the community payment network, as described herein.

FIG. 4 is a flow diagram illustrating an example process that determines payee fee and commissions for a payment transaction, as described herein.

FIG. 5 illustrates a block diagram of select components of a payment service server device(s), as described herein.

FIG. 6 illustrates a block diagram of select components of user device(s), as described herein.

### DETAILED DESCRIPTION

Techniques described herein are directed, at least in part, to a community payment network that uses credits backed by currency. In the techniques described herein, a payee fee can be split and distributed to a plurality of entities (e.g., one or more of a payment service, a user that referred the payor to the community payment network, a bank, a charity, a payor, and the payee in the payor's most recent network transaction preceding the transaction in which the payee fee is being paid). Using techniques described herein, a payee that accepts payment via the community payment network pays a payee fee to the payment service, and a portion of the fee can be paid out by the payment service as commission to other entities, which can include other community payment network users such as the referring user and the previous payee. In various examples, the other entities can also or alternatively include one or more financial institutions and/or one or more non-profits.

Techniques described herein enable a more efficient electronic payment transaction by reducing the number of participants and reducing the number of communications. The unique configuration of devices and applications implemented in the techniques described herein provide enhanced efficiency to electronic payment processing. Instead of a payment processor having to communicate with a card network and issuer for each transaction, a user of the instant payment network can pre-fund a financial account affiliated with the payment service, and credits can be adjusted as the user engages in transactions. Further, payee fees can be lower than traditional electronic transactions, at least partly because of such process and system simplification.

Further, the techniques described herein retain fees that would otherwise be paid to credit card issuers and card networks and distribute them to payment network users and/or other entities, who can be individuals, small businesses, etc.

Paying commissions to the referring user and previous payee serves an incentive to recruit members and accept the payment network form of payment. In this way, membership in the community payment network can grow exponentially or virally. Additionally or alternatively, an incentive to participate in the community payment network is the lower payee fee than is traditionally charged in a credit card transaction or other electronic transaction.

In some examples, a “payment service” is the payment service entity that processes payments or other funds transfers, including authenticating payment information for a transaction, approving a transaction, causing transfer of value between the parties to the transaction, and paying commission to a referring user and a previous payee. In examples, the payment service can offer other services such as inventory management, loyalty program administration, discount distribution, expense analysis and/or tracking, etc.

In some examples, a “user” is a member of the community payment network who uses the community payment network for receipt or provision of payment to another member of the community payment network. The user can be an end-user of a community payment network application (“payment application”) provided by the payment service. For purposes of this discussion “member” and “user” are used interchangeably. Depending on the transaction, a user can be a payor or a payee. As used herein, a “payor” is a user who is providing a payment in a transaction. As used herein, a “payee” is a user who is receiving a payment in a transaction. A user can in some transactions be a payor and in other transactions be a payee. In some examples, a merchant can be a payee when the merchant is receiving payment in a transaction. For the purpose of this discussion, a “merchant” can be any entity that offers items (e.g., goods or services) for acquisition (e.g., sale, lease, free, etc.). In some examples, the transaction can be a peer-to-peer transaction in which the payee is a member of the community payment network who is not a merchant but an individual who is receiving funds from another individual in their personal capacities. For example, payment can be made for a loan, for a private sale, or in other peer-to-peer transactions.

In some examples, a “referring user” or “referrer” of a user is another member of the community payment network that referred the user to enroll with the community payment network. In some examples, referring users and referrals can be identified by the payment service using data submitted in association with an enrollment request from a user. For instance, an invitation from a first member to a second member can be in the form of a code (e.g., QR code, alphanumeric code, etc.) that includes data representative of the identity of the first member. The data can be transmitted to the payment service when the second member includes the code in a request to enroll in the community payment network. In other examples, a referring user can be manually identified by a user as part of an enrollment process. Additionally, a user need not have a referring user to be part of the community payment network. For example, the user can learn of the community payment network on their own and can enroll without having been referred.

In some examples, a “previous payee” is a payee with whom the payor entered a transaction that immediately preceded a pending transaction. In other words, the payee in the payor's most recent historical transaction is referred to as a “previous payee.”

In some examples, a “payee fee” is a fee charged by the payment service to a payee for conducting a transaction via the community payment network. In other words, the payee fee is the cost to the payee for receiving payment via the community payment network. A payee fee can be a set amount, a percentage of a total transaction amount, a combination of a set amount and a percentage, etc. For example, a payee fee can be 1% of a transaction amount, up to a maximum fee. The payee fee can be set by agreement between the payment service and the payee upon payee enrollment. The payee fee can vary by particular payee, by particular payor, by location of the transaction, by merchant category of the payee or the payor, by date of transaction, by transaction history of at least one of the payor or payee, and the like. A payee fee for a particular payee can depend on the particular transaction, and a payee fee for a first payee may not be the same as the payee fee for a second payee in a transaction that is otherwise comparable. In examples, a payee fee may be paid in credits; in examples, the payee fee may be paid in currency.

In some examples, a “community payment network” is a plurality of individuals and/or entities participating in a payment system in which credits are used in transactions in place of currency and in which there is a split commission arrangement that divides a payee fee among at least a referring user of a payor, a previous merchant, and a payment service administering the community payment network. A portion of the payee fee may also be allocated to one or more of a financial institution, a non-profit organization or other charity, etc. “Community payment network” is used interchangeably with “payment network” herein.

In some examples, “bank account” is used interchangeably with “financial account” and is a financial account at a financial institution. In some examples, a “financial institution” can include, but is not limited to, one or more of a commercial bank, a retail bank, an internet bank, a credit union, a savings and loan association, or a brokerage firm.

In some examples, a “funding source” is a repository of resources associated with a user. In some examples, a funding source can be a deposit account or savings account of a user at a financial institution. In some examples a funding source can be a cryptocurrency account of a user. A funding source can additionally or alternatively be a credit card or debit card of the user. A funding source can additionally be gold or another tangible asset owned by a member. In examples, a funding source can be used as a source of a user's funds to fund a PSAB financial account. In some examples, a “payment-service-affiliated bank financial account” or PSAB financial account is a financial account at a financial institution selected by the payment service that falls under a master account the payment service maintains at that bank. The PSAB financial account can be separate from the funding source and can be opened in association with a user enrolling with the community payment network. Funds from a funding source can be transferred to the PSAB financial account and vice versa. In examples, such transfers can be performed using ACH payments or other mechanisms.

In some examples, a “user profile” is a collection of data associated with a user's membership in the community payment network. A user profile can be stored in a data store associated with the payment service and/or a storage device(s) associated with the payment service server device(s). In an example, a user profile can include information regarding a user's identity, funding sources, PSAB financial account, transaction history, referring user, referrals made by the user, credit balance, etc. Stored data can be encrypted and stored on secure servers, which can protect personally identifiable information, details about financial accounts, funding sources, etc.

In some examples, “credits” are units within the community payment network to represent value. In an example, one credit can be equivalent to 1 USD, 100 USD, 1000 USD, or any other dollar amount. In an example in which one credit is equivalent to 1 USD, in a transaction in which a payor obtains goods or services from a payee valued at 100 USD, the payment service removes 100 credits from a payor's credit balance and the payment service can distribute the 100 credits to the payee, payment service, referring user, previous payee, or others in accordance with an example of the method and system described herein.

Techniques described herein are often described as occurring in a retail merchant-customer context in which a merchant is a payee and a customer is a payor. However, techniques described herein can also be applied in other contexts. That is, techniques described herein are not limited to retail merchants, customers, etc. and can also be applied to other contexts such as peer-to-peer (“P2P”) money transfer, lending, invoice settlements, and the like.

Techniques described herein can provide a number of benefits and improvements over conventional techniques. Many of these improvements are technological improvements to the functioning of computers or to other types of technology. For example, by providing for payments via credit transfer within a community payment network, multiple intermediate financial transfers can be avoided. That is, by using credits, a digital substitute for currency, it is unnecessary to transfer funds between financial institutions (e.g., issuer, acquirer, merchant, customer, etc.) after every transaction. Instead, a balance of credits can be maintained for users. A credit balance can be represented by data in a database associated with the payment service. A transaction can simply comprise an update of data (representing a change in a credit balance) performed by a single entity (the payment service). When a user wishes to “cash out” (e.g., convert credits to currency), a credit balance of the user is converted to currency. A transfer from a PSAB financial account of the user to an original funding source of the user (e.g., a personal checking account, savings account, etc.), or to another account is made. A user can engage in a plurality of transactions before cashing out, however, for which credits, not currency, are transferred. Conventionally, a payment transaction involves credits or debits to multiple accounts (issuer, merchant's bank, funds processor, etc.)

In techniques described herein, transactions can be consolidated because of the nature of the community payment network because individual transactions in the payment network do not require “settlement” in a traditional sense. Additionally, commission payments can accumulate without a user needing to take any action and credits need not be cashed out until requested. Eliminating the issuer and eliminating the complex merchant fees and enabling effortless commissions and eliminating or reducing the need for inter-bank communications provide benefits to efficiency, memory, and processing, on the payment service device and obviates the need for other entities and their devices, such as that of card issuer, card network, etc. In at least these ways, technology is improved. Moreover, there can be benefits to the users such as reduced transaction fees, fewer bank transactions, an absence of payment amount caps, etc. Further, the community payment network allows participation by merchants and individuals as equals. In examples, users who are merchants and users who are individuals can pay the same payee fees, receive the same conversion factor, and earn the same commissions when acting as a referring user or “previous payee.” Additionally, the payment service may withhold value from commission payments to pay as taxes in amounts that may be based on the countries in which the transaction is being conducted. The taxes may be paid directly to government entities in some examples. Moreover, value from commission payments may be held back by the payment service and distributed by the payment service to other entities such as charities, non-profit corporations, etc. at the election or designation of a user.

At least for the reasons given above, techniques described herein, and systems described as implementing techniques described herein, are unconventional, non-routine, non-generic, and yield improvements to relevant technologies.

Reference to an “embodiment” in this document does not limit the described elements to a single embodiment; all described elements can be combined in any embodiment in any number of ways. Furthermore, for the purposes of interpreting this specification, the use of “or” herein means “and/or” unless stated otherwise. The use of “a” or “an” herein means “one or more” unless stated otherwise. The use of “comprise,” “comprises,” “comprising,” “include,” “includes,” and “including” are interchangeable and not intended to be limiting. Also, unless otherwise stated, the use of the terms such as “first,” “second,” “third,” “upper,” “lower,” and the like do not denote any spatial, sequential, or hierarchical order or importance, but are used to distinguish one element from another. It is to be appreciated that the use of the terms “and/or” and “at least one of”, for example, in the cases of “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

It should also be appreciated by those skilled in the art that any block diagrams, steps, or sub-processes herein represent conceptual views of illustrative systems embodying the principles of the present subject matter. Similarly, it will be appreciated that any flow charts, flow diagrams, state transition diagrams, pseudo code, and the like represent various processes which can be substantially represented in computer readable medium and so executed by a computer or processor, whether or not such computer or processor is explicitly shown. The order in which the methods are described are not intended to be construed as a limitation, and any number of the described method blocks can be deleted, moved, added, subdivided, combined, and/or modified in any order to implement the methods, or an alternative combination or sub-combinations. Also, while steps, sub-processes or blocks are at times shown as being performed in series, some steps, sub-processes, or blocks can instead be performed in parallel, or can be performed at different times as will be recognized by a person of ordinary skill in the art. Further any specific numbers noted herein are only examples; alternative implementations can employ differing values or ranges. Furthermore, the methods can be implemented in any suitable hardware, software, firmware, or combination thereof.

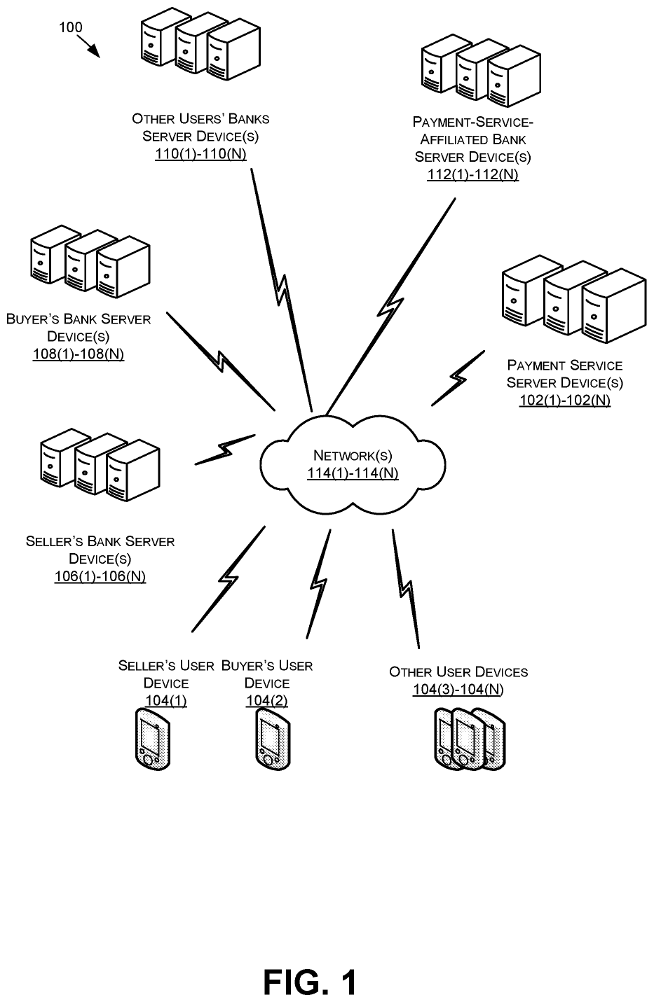

FIG. 1 illustrates an example system 100 for conducting a split commission transaction within a community payment network, as described herein. System 100 includes payment service server device(s) 102(1)-102(N), user device(s) 104(1)-104(N) (including seller's user device 104(1) and buyer's user device 104(2), and other user devices 104(3)-104(N)), seller's bank server device(s) 106(1)-106(N), buyer's bank server device(s) 108(1)-108(N), other users' banks server device(s) 110(1)-110(N), and payment-service-affiliated bank (PSAB) server device(s) 112(1)-112(N). Server devices may be also referred to herein a “server(s)”. The devices of system 100 communicate with each other via network(s) 114(1)-114(N) (e.g., the Internet, cable network(s), cellular network(s), wireless network(s) (e.g., Wi-Fi) and wired network(s), as well as close-range communications such as Bluetooth®, Bluetooth® low energy, and the like).

While a single seller's user device 104(1) and buyer's user device 104(2) are illustrated, in additional or alternate examples, system 100 can have multiple seller devices 104(1) and buyer devices 104(2). Additionally, each user of a plurality of users of the payment service can be associated with a bank, and so system 100 can include a plurality of users' banks server device(s) (106 (1)-106(N), 108(1)-108(N), 110(1)-110(N)) for a plurality of users. Moreover, for simplicity of reference, components throughout this disclosure may be referred to in the singular form and in connection with a single generalized reference numeral. For example, user device(s) 104(1)-104(N) (i.e., the plural form) may be referred to as a user device 104 (i.e., the singular form). Nonetheless, it should be understood that use of the singular form may include the plural form in certain implementations.

One or more of payment service server device 102, user device 104, seller's bank server device 106, buyer's bank server device 108, other users' banks server device 110, or PSAB server device 112 can include any type of computing device that is generally configured to perform an operation. For example, one or more of the payment service server device 102, user device 104, seller's bank server device 106, buyer's bank server device 108, other users' banks server device 110, or PSAB server device 112 can be implemented as a laptop computer, a desktop computer, a server, a smart phone, an electronic reader device, a mobile handset, a personal digital assistant (PDA), a portable navigation device, a portable gaming device, a tablet computer, a watch, a portable media player, a television, a set-top box, a computer system in a car, an appliance, a camera, a robot, a hologram system, a home-based computer system (e.g., intercom system, home media system, etc.), a projector, an automated teller machine (ATM), a pair of glasses with computing capabilities, and so on.

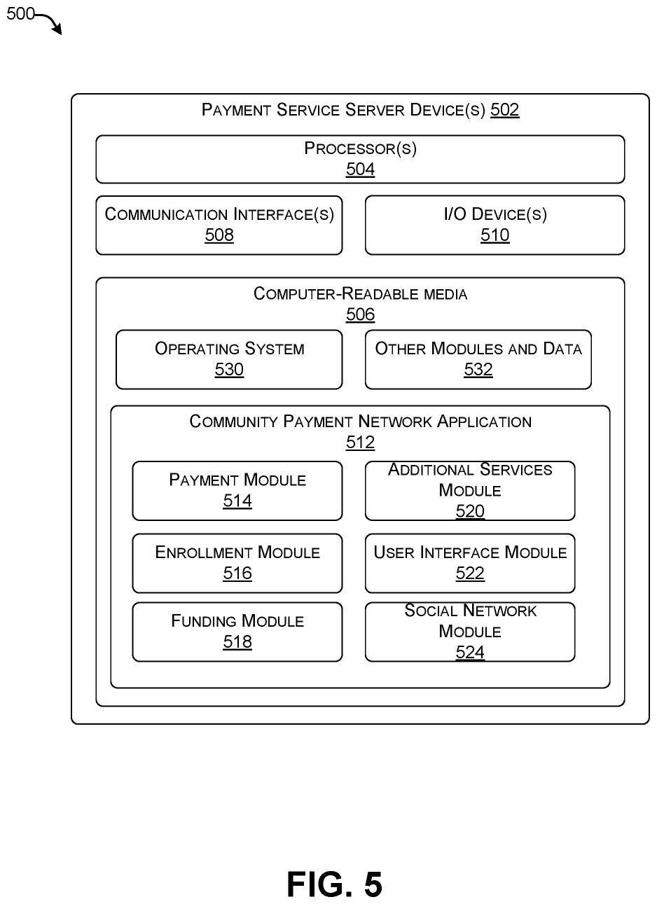

A payment service associated with payment service server device(s) 102(1)-102(N) can constitute an online payment service that processes payments for multiple users. Payment service server device(s) 102(1)-102(N) can expose a network-based application programming interface (API) through which the payment service provides services to multiple users via user devices 104(1)-104(N). For the purpose of this discussion, the payment service and/or the payment service server device(s) 102(1)-102(N) may be any number of servers, an entity, a platform, a service provider, a service provider network, etc. The payment service may maintain a website, platform, database, etc. that is accessible by the users via user devices 104(1)-104(N). In some embodiments, the payment service may offer various network-based (or “cloud-based”) services to the users to fulfill computing needs of the users. In some embodiments, the payment service may operate payment service networks that include clusters of managed servers (or other hardware-based computing devices) stored in data centers located across different geographic regions. Payment service server device(s) 102(1)-102(N) are described further below in the discussion for FIG. 5.

A user device of user devices 104(1)-104(N) can be a point-of-sale (POS) device and can execute a payment application that can be provided by the payment service server device(s) 102(1)-102(N) to perform activities associated with the payment network. User devices 104(1)-104(N) are described further below in the discussion for FIG. 5.

Seller's bank server device(s) 106(1)-106(N) and buyer's bank server device(s) 108(1)-108(N) can be associated with banks or other financial institutions at which seller and buyer, respectively, have financial accounts.

PSAB server device(s) 112(1)-112(N) can be associated with a PSAB bank designated by the payment service to open and hold payment network-related financial accounts. PSAB server device(s) 112(1)-112(N) maintain PSAB financial accounts for users of the community payment network. The payment service can hold a master account at the PSAB, to which the users' financial accounts can be associated. Payment service server device(s) 102(1)-102(N) can cause PSAB server device(s) 112(1)-112(N) to open a PSAB financial account for a user upon the user's enrollment with the community payment network. Payment service server device(s) 102(1)-102(N) can provide the PSAB bank information about users (e.g., name, social security number, address, citizenship, etc.), which can be obtained via an enrollment process or through queries to users, to open a PSAB financial account on the users' behalf. In examples, an alternative financial institution to the PSAB can be used (if a user is not qualified to open a U.S. bank account, for example).

In embodiments, no PSAB device 112(1)-112(N) is included in system 100. In such embodiments, users can use their own funding sources (e.g., financial accounts held at their own financial institutions (e.g., 106(1)-106(N), 108(1)-108(N), or 110(1)-110(N))) as financial backing for the credits used in the community payment network.

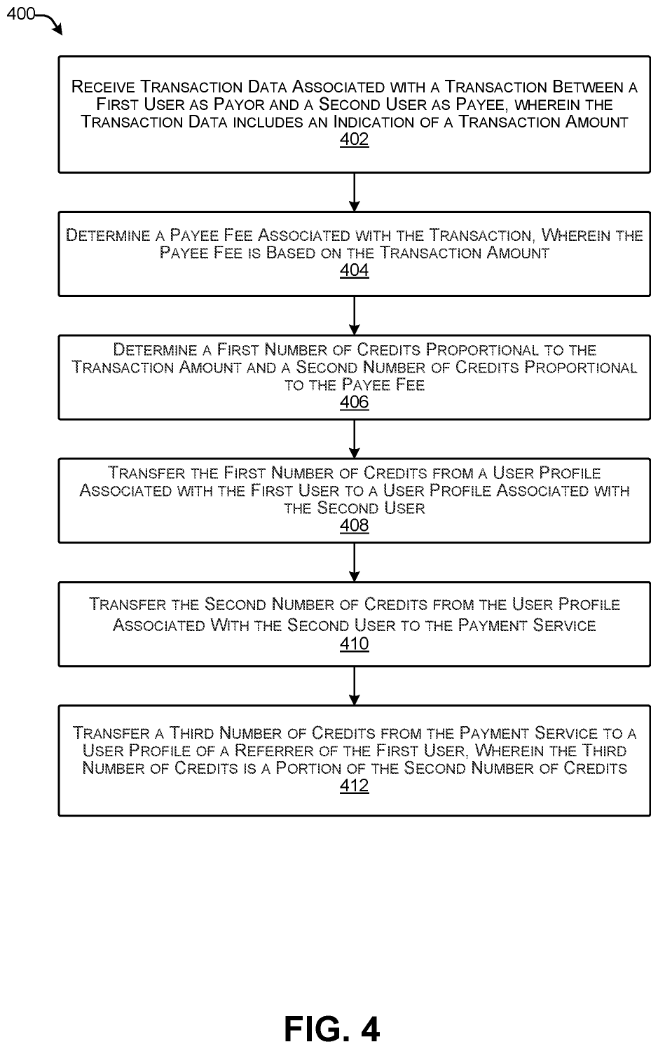

At least some additional components and functions of, and interactions between, devices in example system 100 are described below (at least with respect to FIGS. 4 and 5).

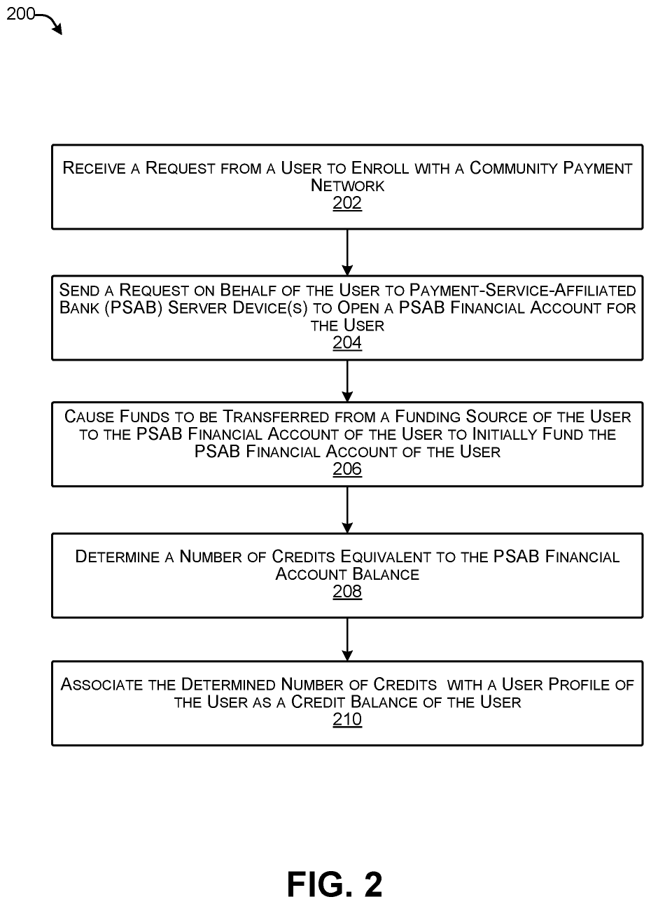

FIG. 2 is a flow diagram illustrating an example process 200 for enrolling a new user with a community payment network, as described herein.

Block 202 illustrates receiving a request from a user to enroll with a community payment network. Payment service server device(s) can receive the request from a user device, via web form, email, direct message, application notification, etc. In examples, the request can include or be associated with referring user information. Referring user information identifies an existing member of the payment network who referred the user to the payment service. Referring user information can be embedded as data in an enrollment request. In an example, a user can scan a QR code presented by a merchant user or activate a URL provided by the merchant that directs the user to an enrollment interface. In an example, scanning a QR code with a user device can cause a browser window to open on the user device, from which payment service server device(s) can obtain enrollment information input by the user. In examples, for a user to qualify as a referring user in the payment network, the referee must enroll within a threshold time of the user providing the referee the QR code or URL. For instance, the payment service can timestamp the QR code upon its generation and compare that timestamp with an enrolling user's first contact with the payment service. Additionally or alternatively, a user can provide an enrolling user a code. When the enrolling user provides the code to the payment service during enrollment, the user that provided the code to the enrolling user is acknowledged by the payment service as the referring user. Additionally or alternatively, referring user information can be obtained by payment service server device(s) separately from an enrollment request. An identifier for a referring user can be stored by the payment service in association with a new user profile for the user, which can be stored in a data store associated with payment service server device(s).

In examples, a user can enroll at a time of a transaction with a referring user. Transaction data, an enrollment link, and a referring user identifier can be obtained by a user device of the user (e.g., by scanning a QR code presented to the user by a merchant via a merchant device). In examples, the user can enroll before performing any transaction in the community payment network. In an example, a user device can scan a QR code displayed by a merchant device or posted at a merchant location, such that the merchant associated with the merchant device can be qualified as the referring user though no transaction has yet occurred. In other examples, a user can enroll by visiting a webpage of the community payment network without having been directly referred, such that, in examples, commissions from the user's transactions do not get split three or more ways (e.g., payment network, previous merchant, referring user), but at most two ways (payment network, previous merchant). In a first transaction within the payment network by a user with a user profile for whom no referring user has been associated, the payment network retains the full payee fee (or equivalent credits) because there is neither a previous merchant nor a referring user. Once the user is enrolled, the user can conduct transactions within the payment network.

As part of the enrollment process, payment service server device(s) can request identifying information regarding a funding source of a user. This funding source (e.g., checking account, etc.) can be used to fund a user's PSAB financial account or can be used for provision of direct backing of credits exchanged in the community payment network. Credits can be backed by U.S. dollars or by another currency, cryptocurrency, or other value mechanism. Different users' credits can be backed by different currencies or value mechanisms.

Block 204 illustrates sending a request on behalf of a user to PSAB server device(s) to open a PSAB financial account for a user. A bank can be selected by the payment service to be the PSAB, and the payment service can maintain a master or umbrella account at the PSAB for all accounts opened for users of the payment service. The payment service can store an association between the user's new PSAB financial account and the user's user profile in the community payment network. An association between the user's funding source and the user profile can also be stored, thereby allowing a determination of a user's PSAB financial account and funding source given the user's identifier. In some examples, the payment service or the PSAB can communicate with the user (via email, direct message, application notification, etc.) to obtain additional information from the user after initial enrollment in order to open the PSAB financial account (e.g., to obtain direct authorization from the user to open the PSAB financial account). In some examples, no PSAB financial account is opened, but instead, transfers occur directly between the payee and payor funding sources (e.g., checking account, etc.), or the funding source of one user and a PSAB financial account of a second user. In an example in which a user does not use or have a PSAB financial account, a user can agree that the user's funding source may be debited in order to add credits to the user's credit balance associated with the user's user profile. A user can agree that if the credit balance falls below a minimum threshold, additional funds can be transferred to the payment service to increase the credits associated with the user. When a user wishes to “cash out,” funds can be transferred from the payment service to the user's funding source. Similarly, in examples in which a PSAB financial account is present, a user can agree to automatic replenishment of the PSAB financial account from the user's funding source if the balance of the PSAB financial account falls below a minimum threshold.

Block 206 illustrates causing funds to be transferred from a funding source of the user to the PSAB financial account of the user to initially fund the PSAB financial account of the user. For example, the payment service can initiate an ACH transfer between a funding source and a PSAB financial account. In some examples, a user authorizes a particular amount for the transfer via an input to a payment application executing on a user device of the user, a direct message, email, a web form entry, etc. In some examples, the payment service can suggest an amount for the transfer or require a minimum amount as an initial funding of the PSAB financial account. The user can authorize automatic transfers from the funding source to the PSAB financial account. In examples, an automatic transfer occurs when the PSAB financial account balance falls below a minimum threshold amount.

Block 208 illustrates determining a number of credits equivalent to the PSAB financial account balance. As described below, a conversion factor of credits to currency can be used both in determining how many credits a certain currency amount is worth, and in determining a currency amount a number of credits is worth (e.g., such as when “cashing out” credits, as discussed below).

Block 210 illustrates associating determined the number of credits with a user profile of the user as a credit balance of the user.

A user can “cash out” credits at any time. In examples, to do so, a user submits a request to the payment service. The request can include an amount of credits the user wishes to cash out and can identify an account to which the funds should be transferred. The identified account can be the funding source that originally funded the PSAB financial account or can be another disbursement method. Responsive to receiving the request, the payment service causes a transfer of funds from the PSAB financial account back to the identified account (or alternative type of disbursement). The amount of credits that can be cashed out can be limited by a minimum credit balance that must be maintained as part of the terms of the community payment network. However, if a user intends to disenroll in the community payment network, all credits can be cashed out. In examples, when a user disenrolls, the complete cash-out occurs automatically.

If a transaction causes a credit balance of a user to fall below what is equivalent to a currency amount in the user's PSAB financial account, (e.g., the user conducts a transaction that causes the credit balance to fall below the credit-equivalent of the $10 in the user's PSAB financial account), the payment service can request authorization of a transfer from the user's funding source (e.g., by an ACH transfer, etc.). Alternatively, in an example, no authorization is required when the user profile allows automatic replenishments of the PSAB financial account. For instance, given a 1:1 credits to dollars conversion factor, a $100 balance in the user's PSAB financial account, a pending transaction for $50, and a minimum balance for the PSAB financial account of $75, the payment service can cause transfer of $25 at or about the time of the transaction.

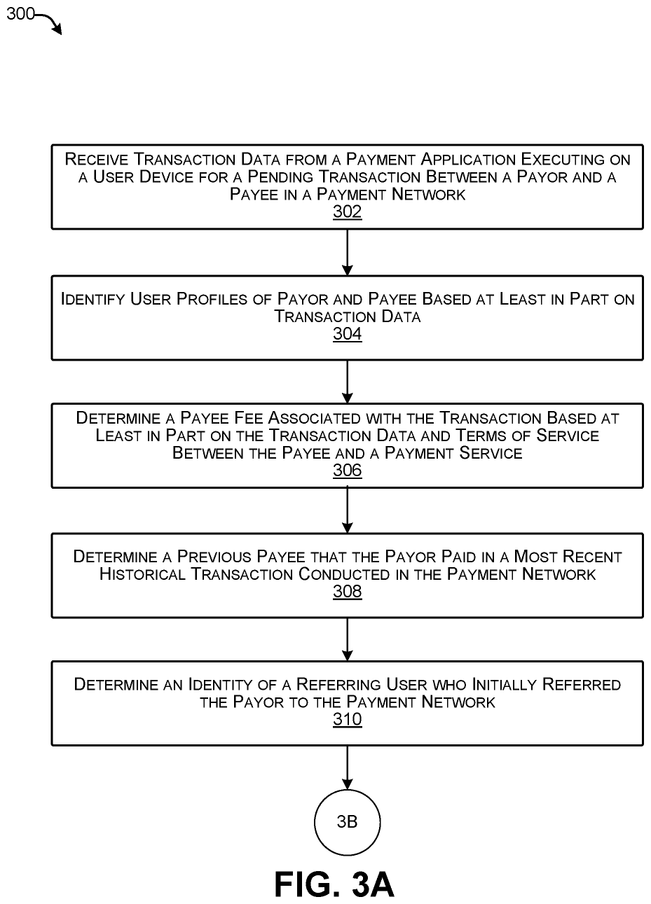

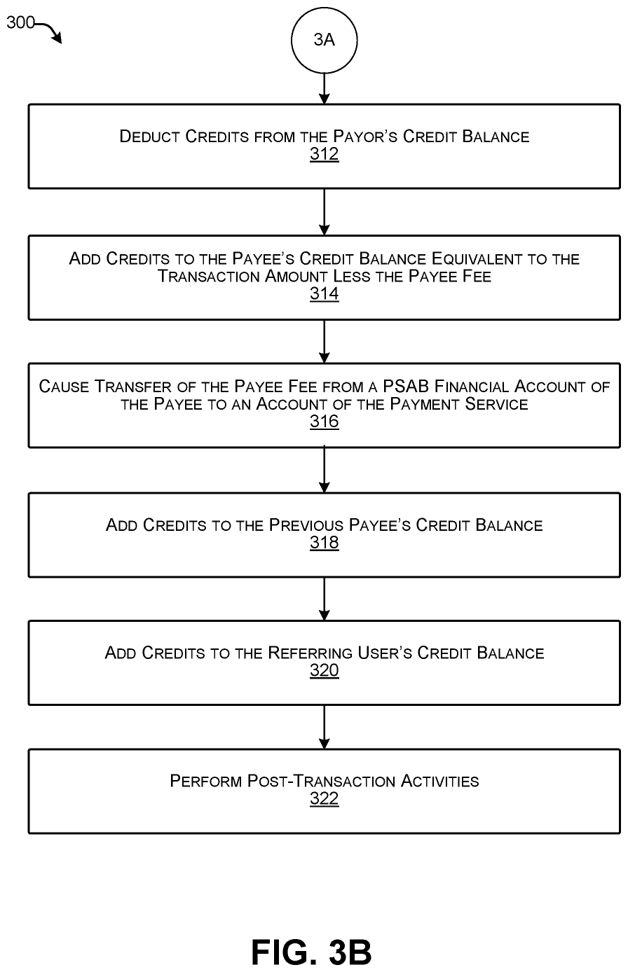

FIGS. 3A and 3B are a flow diagram illustrating an example process 300 for conducting a split-commission transaction in the community payment network, as described herein.

Block 302 illustrates receiving transaction data from a payment application executing on a user device for a pending transaction between a payor and a payee in a payment network. In examples, the payment application is a mobile payment application. In examples, the transaction data may be received by the payment service from a payment application executing on a user device of a payor (such as buyer's user device 104(2)) for a transaction between a payor and a payee. In examples, transaction data may be received by the payment service from a POS device. In examples, the payor can be a customer of the payee, who can be a merchant. The transaction data can include conventional information (e.g., transaction amount, transaction location, items or services purchased, identity of the merchant, etc.). The transaction data can also include a payor identifier, which, in some examples, can be appended to the conventional transaction data by the particular instance of the payment application executing on the user device of the payor. The transaction data can be obtained by the payment application instance executing on the user device of the payor, either from the user device of the payee, via manual entry, etc. Alternatively, transaction data can be received from an instance of the payment application executing on a user device of a payee (such as seller's user device 104(1)) for a transaction between a payor and a payee. In an example, the user device of the payee obtains and appends a payor identifier via manual entry by the payor or the payee (e.g., entry of a phone number on a user interface of the user device of the payee, scanning an identifier with an image capturing component of the user device of the payee wherein the identifier can be displayed on a display of user device of the payor, etc.).

In some examples, transaction data can be generated in the first instance by a point-of-sale (POS) application that is separate from the payment application. In some examples, the transaction data can be generated in the first instance by a POS device that can be communicatively coupled to a user device of the payee. In examples, the user device of the payee can be a POS device.

Payment service server device(s) can cause one or more user interfaces to be presented on a user device via a payment application executing on a user device. The one or more user interfaces can display controls to allow a user to cause a transfer of funds between financial accounts associated with the user's user profile, to indicate an intent to make a purchase or transfer value to another user, to indicate an intent to accept value (e.g., credits) being transferred to the user from another user, to check a credit balance, to modify a user profile, to review a transaction history, to search a transaction history, to search for participating users of the community payment network (e.g., search by name, location, or other criterion), to view a conversion factor, to determine an exchange rate between different currencies, to communicate with other users or the payment service, to participate in a social network provided by the payment service, to initiate a scan by the user device of a barcode, QR code, or other graphic that can, for example, represent transaction data for a pending transaction or include an identifier of another user with which the user wishes to enter a transaction, etc.

Block 304 illustrates identifying user profiles of the payor and the payee based at least in part on the transaction data. As described above, the payment service server device(s) can receive the transaction data in any of a variety of ways, including those described above relative to Block 302. The transaction data can include identifiers for the payor and payee. The payment service server device(s) can map the payor identifier to the user profile of the payor and maps the payee identifier to the user profile of the payee, wherein the user profiles can be stored by the payment service.

Block 306 illustrates determining a payee fee associated with the transaction based at least in part on the transaction data and terms of service between the payee and the payment service. In some examples, the payee fee can be calculated as a percentage of the transaction amount (e.g., 0.5%, 1.0%, 1.5%, etc.). For instance, if the payor is purchasing shoes from the payee that cost $50.00, and the payee fee agreed to by the seller is 1.0%, then the payee fee is $0.50. Agreement to the payee fee can be made at the time of enrollment of a user and the payee fee can be adjusted by the payment service, with agreement of the user. In some examples, the payee fee can be calculated as a flat fee plus a percentage of the transaction amount. For instance, in the example above in which the transaction amount is $50, if the payee fee is 1.0% plus $1.00, then payee fee would be $1.50. In some examples, the total payee fee is capped (e.g., at $10.00, $15.00, $20.00, etc.).

Block 308 illustrates determining a previous payee that the payor paid in a most recent historical transaction conducted in the payment network. Determining a most recent payee can be based on transaction records stored by the payment service server device(s). In examples, the payment service server device(s) and user devices can be coupled across the network to a storage device (not shown) that stores the transaction records, user profiles, etc. Additionally or alternatively, the storage device can reside locally with respect to the payment service server device(s), the user device(s), or both. In certain implementations, the storage device(s) can include one or a combination of computer readable media. The payment service server device(s) analyzes the payor's purchase history based at least in part on the payor's user profile and determine the identifier of the payee in the transaction conducted by the payor immediately preceding the pending transaction.

Block 310 illustrates determining an identity of a referring user who initially referred the payor to the payment network. The identity of the referring user can be stored in the user profile of the payor.

Block 312 illustrates deducting credits from the payor's credit balance. A user's credit balance (here, the payor's credit balance) can be stored in association with a user profile of the user. The number of credits deducted from the credit balance is calculated by multiplying the transaction amount by a conversion factor of credits per unit of currency. In an example in which the transaction amount is 100 USD, and the conversion factor for credits to USD is 1:1, 100 credits can be deducted from the payor's user profile. The conversion factor of credits to currency can vary by date, location, user, type of goods/services, transaction history, etc. and can be set by the payment service. The payment service can disclose the conversion factor(s) to users as part of initial terms and conditions of community payment network participation. Similarly, the payment service can provide notice of changes to the conversion factor during the user's enrollment in the payment service. Agreement to the use of a conversion factor(s) by a user can be implied based on the user's continued use of the community payment network. In a cross-border transaction (e.g., when a payor is in Mexico and a payee is in the United States), the credit calculations can be performed by using a conversion factor applicable to the currency used in the transaction. Alternatively or additionally, currency may be deducted from a payor's PSAB account for the transaction amount.

Block 314 illustrates adding credits to the payee's credit balance equivalent to the transaction amount less the payee fee. The credits can be calculated by determining the transaction amount less the payee fee, multiplied by an applicable conversion factor. The number of credits can be calculated with the equation C=(T−F)*R, wherein C=credits to payee, T=transaction amount in currency of transaction, F=fee amount in currency of transaction, and R=conversion factor of credits per unit of currency. For instance, if a transaction amount is 100 USD, a payee fee is 1 USD, and credits per USD are 0.05, C=99 USD*0.05 credits/USD=4.95 credits. In another example, if a transaction amount is 100 €, a payee fee is 5 €, and credits per € are 0.08, C=95 €*0.04 credits/€=3.8 credits. Alternatively or additionally, currency may be added to a payor's PSAB account or other financial account for the transaction amount.

Block 316 illustrates causing a transfer of the payee fee from a PSAB financial account of the payee to an account of the payment service. The payment service can maintain a financial account and/or can store a credit balance for credits associated with the payment service. The payment service can receive a payee fee in credits or the equivalent amount of currency or some combination of credits and currency. Credits can be transferred from the payee's credit balance; currency can be transferred from the payee's PSAB financial account.

Block 318 illustrates adding credits to the previous payee's credit balance. The added credits can be some portion of the credits equivalent to the payee fee. In at least one example, the portion ranges from at least about 0.1% to at most about 75.0%, or from at least about 10% to at most about 50%, and/or from at least about 25% to at most about 60%. However, the percentage need not be limited to this range and can be set by the payment service (and agreed to by users) at any amount. When no previous payee is identified (for example, if this is the first payment by this payor), these credits can simply not be disbursed.

Block 320 illustrates adding credits to the referring user's credit balance. The referring user's credit balance can be stored in association with a user profile of the referring user. The added credits can be some portion of the credits equivalent to the payee fee. In at least one example, the portion ranges from at least about 0.1% to at most about 75.0%, or from at least about 10% to at most about 50%, and/or from at least about 25% to at most about 60%, but the percentage need not be limited to this range and can be set by the payment service (and agreed to by users) at any amount. The previous payee portion and the referring user's portion can be the same percentage or different percentages. When no referring user is identified (for example, if the payor enrolled without a referral), these credits can simply not be disbursed. Thus, when there are both a previous payee and a referring user, in effect, the payee fee paid by the payee can be split between at least the payment service, the referring user, and the previous payee. In various examples, the payee fee can be split between the payment service, the referring user, the previous payee, and one or more other entities that can include one or more financial institutions and/or one or more non-profits. The percentage of the payee fee retained by the payment service can be equivalent to the percentage allotted to the previous payee and/or referring user and can also be greater to or less than the percentage allotted to the previous payee and/or referring user. The payor may receive a portion of the commission (e.g., as “cash back”) in some examples, which may reduce the portions distributed to at least the previous merchant and/or referring user.

Block 322 illustrates performing post-transaction activities. The payment service can provide additional services after the transaction such as storing details of the transaction, providing a receipt to the buyer, presenting transaction data on a user interface of a display of a user device, updating loyalty rewards, etc. The payment service server device(s) can send the buyer device a receipt via email, message, etc., can send a link, can cause the payment application on the buyer device to do a notification, or can enable access to the receipt in the payment application.

FIG. 4 is a flow diagram illustrating an example process 400 that determines a payee fee and commissions for a payment transaction, as described herein.

Block 402 illustrates receiving transaction data associated with a transaction between a first user as payor and a second user as payee, wherein the transaction data includes an indication of a transaction amount. Transaction data can be relayed to the payment service by at least either participant in a transaction. Transaction data can include at least one of transaction amount, desired date and time of transfer, payor identity, payee identity, free-form notes of a user(s), location(s), item(s) or service(s) being purchased, etc.

Block 404 illustrates determining a payee fee associated with the transaction, wherein the payee fee is based on the transaction amount. In examples, the payee fee is a flat fee or a combination of a flat fee and a percentage of the transaction amount. The payee fee is not limited to these amounts and can be set by the payment service.

Block 406 illustrates determining a first number of credits proportional to the transaction amount and a second number of credits proportional to the payee fee. The first number of credits and second number of credits can be calculated using a conversion factor of credits to currency unit.

Block 408 illustrates transferring the first number of credits from a user profile associated with the first user to a user profile associated with the second user. The payment service can deduct credits from a payor user. Although the term “transfer” is used in this specification, the changes to credit balances can be seen as deductions or additions without reference to a “transfer” from or to another user. That is, a “transfer” from payor to payee can be described instead as the payor being debited credits and the payee being provided credits. Alternatively or additionally, the transaction amount can be transferred from a first user account to a second user account.

Block 410 illustrates transferring the second number of credits from the user profile associated with the second user to the payment service. In examples, the payee fee can be paid to the payment service in credits deducted from the payee's credit balance. In other examples, the payee fee can be paid to the payment service in currency deducted from the payee's PSAB financial account (or, in the absence of a PSAB financial account, from the payee's funding source).

Block 412 illustrates transferring a third number of credits from the payment service to a user profile of a referrer of the first user, wherein the third number of credits is a portion of the second number of credits. In some embodiments, the transfer of credits to the third user can be described as a transfer directly from payee to third user without first being assigned to the payment service. In examples, a fourth number of credits can be transferred from the payment service to a user profile associated with a fourth user, wherein the first user paid the fourth user in an earlier transaction occurring immediately prior to the transaction, and wherein the fourth number of credits comprises a second portion of the second number of credits. In some embodiments, the transfer of credits to the fourth user can be described as a transfer directly from payee to fourth user without first being assigned to the payment service. However, in examples in which there is no prior payee or no referring user, the allotment of credits to the prior payee or referring user can be assigned to the payment service rather than remaining with the payee.

Additionally, in some examples, the payer may receive a portion of the payee fee (e.g., as “cash back” for a transaction). The payer may pay the payee with credits or currency and receive credits or currency back for the transaction. The payer's portion of the payee fee may be associated with a user profile of the payer in credits or currency.

FIGS. 2, 3A, 3B, and 4 are flow diagrams illustrating example processes according to some implementations. The processes of FIGS. 2, 3A, 3B, and 4 are illustrated as collections of blocks in logical flow diagrams, which represent a sequence of operations, some or all of which can be implemented in hardware, software, or a combination thereof. In the context of software, the blocks can represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. Further, in some examples, some or all of the operations illustrated in one or more of FIGS. 2, 3A, 3B, and 4 can be combined with some or all of the operations illustrated in others of FIGS. 2, 3A, 3B, and 4. For discussion purposes, the processes are described with reference to the environments, architectures and devices described in the examples herein, although the processes can be implemented in a wide variety of other environments, architectures, and devices.

FIG. 5 illustrates a block diagram 500 of select components of a payment service server device(s) 502, as described herein.

Payment service server device(s) 502 can include one or more servers or other types of computing devices that can be embodied in any number of ways. For example, in the example of a server, the modules, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of payment service server device(s) 502 as being present in a single location, these components and data can alternatively be distributed across different computing devices and different locations in any manner. Multiple payment service server device(s) 502 can be located together or separately, and organized, for example, as virtual servers, server banks, and/or server farms. The described functionality can be provided by the servers of a single entity or enterprise, or can be provided by the servers and/or services of multiple different customers or enterprises.

In the illustrated example, payment service server device(s) 502 can include one or more processors 504, one or more computer-readable media 506, one or more communication interfaces 508, and one or more input/output devices 510. Each of the processor(s) 504 can be a single processing unit or a number of processing units, and can include single or multiple computing units or multiple processing cores. The processor(s) 504 can be implemented as one or more microprocessors, microcomputers, microcontrollers, digital signal processors, central processing units, state machines, logic circuitries, and/or any devices that manipulate signals based on operational instructions. For example, processor(s) 504 can be one or more hardware processors and/or logic circuits of any suitable type specifically programmed or configured to execute the algorithms and processes described herein. Processor(s) 504 can be configured to fetch and execute computer-readable instructions stored in computer-readable media 506, which can program processor(s) 504 to perform the functions described herein.

Computer readable media 506 includes computer storage media and computer-readable signals. Computer storage media includes volatile and non-volatile, removable and non-removable media implemented in any method or technology for storage of information, such as computer readable instructions, data structures, program modules, or other data. Computer storage media includes, but is not limited to, solid-state memory, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In addition, in some examples the computer readable media can be associated with transitory computer-readable signals (in compressed or uncompressed form). Examples of computer-readable signals, whether modulated using a carrier or not, include, but are not limited to, signals that a computer system hosting or running a computer program can be configured to access, including signals downloaded through the internet or other networks.

Depending on the configuration of payment service server device(s) 502, computer-readable media 506 can be an example of tangible non-transitory computer storage media Further, in some examples, payment service server device(s) 502 can access external storage, such as RAID storage systems, storage arrays, network attached storage, storage area networks, cloud storage, or any other medium that can be used to store information and that can be accessed by the one or more processors directly or through another computing device or network. Accordingly, computer-readable media 506 can be computer storage media able to store instructions, modules, or components that can be executed by the processor(s) 504.

Computer-readable media 506 can be used to store any number of functional components that are executable by processor(s) 504. In many implementations, these functional components comprise instructions or programs that are executable by processor(s) 504. Functional components stored in computer-readable media 506 can include payment module 514, enrollment module 516, funding module 518, additional services module 520, user interface module 522, and social network module 524, which can comprise at least a portion of community payment network application (“payment application”) 512. Payment application 512 can be provided by the payment service server device(s) 502 and can be configured to allow a user to perform the functions associated with the community network payment.

The term “module” is intended to represent example divisions of the software for purposes of discussion and is not intended to represent any type of requirement or required method, manner or necessary organization. Accordingly, while various “modules” are discussed, their functionality, similar functionality, or both, could be arranged differently (e.g., combined into a fewer number of modules, broken into a larger number of modules, etc.). The modules can include computer instructions/code that can be stored in the computer-readable media 506 and can be executable by processor(s) 504.

The payment module 514 can be configured to create, receive, and/or transmit transaction data for an electronic transaction conducted within the community payment network. In some examples, either user in a transaction can submit the transaction data to the payment service via an instance of a payment application provided by the payment service that is executing on a user device. For instance, if a payee is submitting the transaction, the payee can obtain authorization of the payor before doing so, either via a control on the user device of the payor or by a control on the user device of the payee. Additionally or alternatively, based at least in part on transaction data, the payment module 514 can deduct credits from a credit balance of the payor equivalent to the transaction amount, determine a payee fee for the transaction, add credits to the credit balance of the payee equivalent to the transaction amount less the payee fee, add a portion of the payee fee (e.g., in credits equivalent to the payee fee) to a credit balance of the previous payee, add a portion (the same or different from the portion for the previous payee) of the payee fee to a credit balance of the referring user, and retain the remaining payee fee for the payment service. Additionally or alternatively, the payment module 514 can access a conversion factor or exchange rate between credits and currency in order to perform the transfers described above. The conversion factor can be set by agreement between the payment service and one or more users participating in the community payment network.

The enrollment module 516 can be configured to enable receipt of enrollment information from a user. In some examples, a user downloads the payment application before enrollment and uses the payment application to submit enrollment information. The enrollment module 516 and user interface module 522 can cause a form to be displayed to the user for entry of enrollment information. The enrollment module can be configured to confirm with the payment service that a user is not already enrolled (e.g., by requesting at least one of the user's email address, phone number, name, etc.) before requesting enrollment information. The enrollment module can detect receipt of referring information from a referring user and associate the user's enrollment information with the referring user (by the payment service server device(s) at the time the enrollment information is received, or by the user device before the enrollment information is sent) so that the referring user receives credit for future transactions of the enrolling user.

The funding module 518 can be configured to transfer funds from a user's personal funding source to the user's PSAB financial account. In examples, the funding module 518 can determine the funding source based at least in part on information provided by a user. Based at least on permission from the user, the funding module can cause a transfer of funds between the funding source and the financial account. The financial account can be used to back credits assigned to the user by the payment service. In some examples, the payment service retains some or all control over the financial account so that as a user's credit balance decreases, the funding module 518 can withdraw a proportional amount of funds from the financial account. Upon a user leaving the community payment network or upon request of a user, the funding module 518 can cause a transfer of the financial account's balance to the user's funding source or to another account of the user's choosing. Additionally or alternatively, the funding module can manage credit balance adjustments corresponding to payment network transactions, including commissions.

The additional services module 520 can be configured to provide additional services of the payment service to the user. For example, the additional services module 520 can cause a storage device to store details of the transaction, provide a receipt to the users involved in the transaction, cause transaction data to be displayed (in cooperation with the user interface module 522) on a user interface of a display of a user device, update loyalty rewards that can be administered by the payment service, cause transaction information to be displayed via an external social network or a social network associated with the community payment network, etc. In examples, the additional services module 420 can send a user device a receipt via email, message, etc., can send a URL link to a user device, can cause a payment application on a user device to display a notification associated with a receipt, or otherwise enable access to a receipt via the payment application. Additionally or alternatively, the payment service can offer other additional services such as inventory management, discount distribution, etc.

User interface module 522 can be configured to perform acts that can include causing a user interface to be provided to a user via a display of a user device. In examples, the user interface module 522 can cause a user interface to be displayed that allows a user to at least one of select a payee or payor for a transaction, input a transaction amount, request a credit balance, request a balance of a PSAB financial account, transmit a message to the payment service or to another user of the payment network, request a transaction history of the user, request a map of nearby users of the payment network, request of a list of other users that the user has referred to the payment network, request an identity of the referring user of the user, request a summary view of a user profile or dashboard of the user's participation in the payment network or aggregation of information from a plurality of transactions that are determined to be associated with the user profile. Additionally or alternatively, the acts can include generating a user interface that allows a user to perform actions including one or more of view, sort, filter, or any combination thereof, at least a portion of information at varying levels of granularity. Additionally or alternatively, user interface module 522 can cause a user interface to be provided to a user to prompt entry of user credentials for, for example, a user profile and/or a PSAB financial account. Additionally or alternatively, the acts can include linking a financial account and/or funding source to the user's user profile.

In certain instances, user interface module 522 can be configured to provide a user interface corresponding to the user device being used. For example, information can be presented to the user in a different manner when presented on a mobile phone than when presented on a personal computer.

In some examples, the user interface can be provided to a user via a web browser (e.g., software as a service (SaaS)), via a downloadable client application, or both.

The social network module 524 can be configured to enable a user to interact regarding transaction activity within the community payment network, in a social forum. For example, the social network module 524 can provide for integration of one or more social networks within the payment network. A social network can be provided by the social network module 524 such that a user can interact with other users of the payment network. Further, external social networks can be integrated within the payment network via third-party applications, thereby allowing a user of the payment network to engage with users of the external social networks.

Additional functional components stored in computer-readable media 406 can include operating system 530 for controlling and managing various functions of payment service server device(s) 502. In at least one example, computer-readable media 506 can additionally include or maintain other functional components and data, such as other modules and data 532, which can include programs, drivers, etc., and the data used or generated by the functional components. Further, payment service server device(s) 502 can include many other logical, programmatic, and physical components, of which those described above are merely examples that are related to the discussion herein.

Communication interface(s) 508 can include one or more interfaces and hardware components for enabling communication with various other devices, such as over network(s) or directly. For example, communication interface(s) 508 can enable communication through one or more networks, which can include, but are not limited to any type of network known in the art such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. A network can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Payment service server device(s) 502 can further be equipped with various input/output (I/O) devices 510. I/O device(s) 510 can be configured to allow a user to interface with the payment service server device(s) 502 via one or more I/O devices. The I/O device(s) 510 can provide an interface for such devices as a display (not shown), audio speakers (not shown), a microphone (not shown), a camera (not shown), connection ports (not shown), an optical reader (not shown), a touchpad (not shown), a haptic output device (not shown), various user interface controls (e.g., buttons, joystick, keyboard, mouse, touch screen, etc.) (not shown), or any combination thereof.

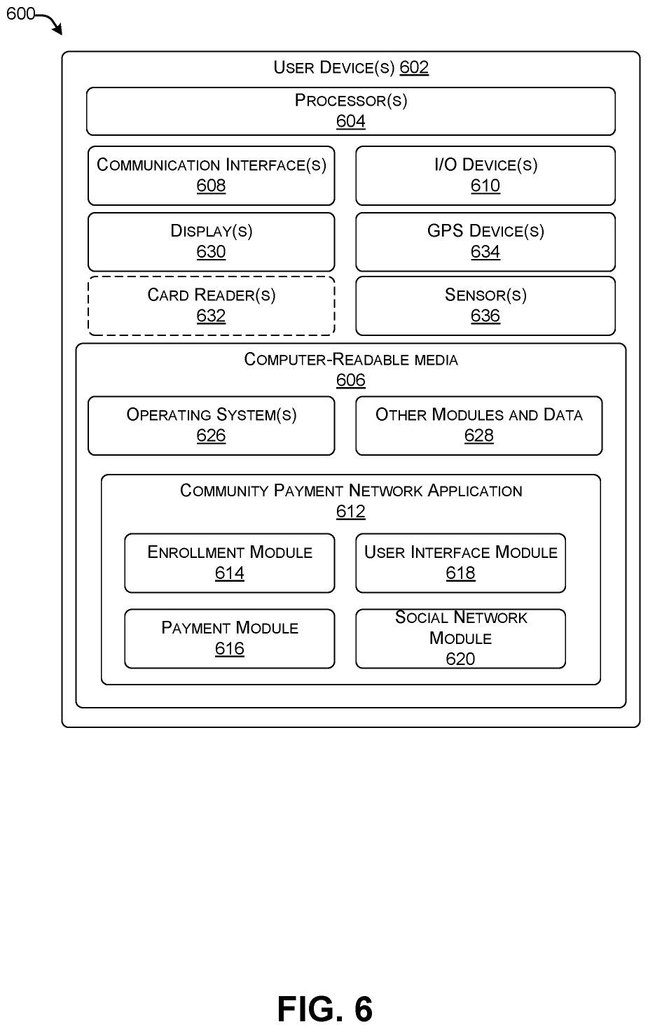

Those of ordinary skill in the art will appreciate that the hardware components and various functional modules depicted in FIGS. 5, 6, and elsewhere can vary. The illustrative components are not intended to be exhaustive, but rather are representative to highlight components that are utilized to implement the subject matter disclosed in the present application. For example, other devices/components can be used in addition to or in place of the hardware depicted. In addition, the various components illustrated in storage and memory can be alternatively located in any storage or memory across the network(s) 114(1)-114(N). The depicted example is not meant to imply architectural or other limitations with respect to the subject matter of this disclosure.

FIG. 6 illustrates a block diagram 600 of select components of user device(s) 602, as described herein.

In at least one example, user device(s) 602 can be any suitable type of mobile device, e.g., portable, semi-portable, or semi-stationary. Some examples of user device(s) 602 can include tablet computing devices; smart phones and mobile communication devices; laptops, netbooks and other portable computers or semi-portable computers; wearable computing devices, or other body-mounted computing devices; augmented reality devices; or other computing devices capable of sending communications and performing the functions according to the techniques described herein.

In the illustrated example, user device(s) 602 can include one or more processors 504, one or more computer-readable media 606, one or more communication interface(s) 608, and one or more input/output (I/O) device(s) 610. Each processor 604 can itself include one or more processors or processing cores. For example, processor(s) 604 can be implemented as one or more microprocessors, microcomputers, microcontrollers, digital signal processors, central processing units, state machines, logic circuitries, and/or any devices that manipulate signals based on operational instructions. In some examples, the processor(s) 604 can be one or more hardware processors and/or logic circuits of any suitable type specifically programmed or configured to execute the algorithms and processes described herein. The processor(s) 604 can be configured to fetch and execute computer-readable processor-executable instructions stored in computer-readable media 606, which can program processor(s) 604 to perform the functions described herein.

Computer readable media 606 includes computer storage media and computer-readable signals. Computer storage media includes volatile and non-volatile, removable and non-removable media implemented in any method or technology for storage of information, such as computer readable instructions, data structures, program modules, or other data. Computer storage media includes, but is not limited to, solid-state memory, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In addition, in some examples the computer readable media can be associated with transitory computer-readable signals (in compressed or uncompressed form). Examples of computer-readable signals, whether modulated using a carrier or not, include, but are not limited to, signals that a computer system hosting or running a computer program can be configured to access, including signals downloaded through the internet or other networks.

Depending on the configuration of user device(s) 602, computer-readable media 606 can be an example of tangible non-transitory computer storage media. Further, in some examples, user device(s) 602 can access external storage, such as RAID storage systems, storage arrays, network attached storage, storage area networks, cloud storage, or any other medium that can be used to store information and that can be accessed by the one or more processors directly or through another computing device or network. Accordingly, computer-readable media 606 can be computer storage media able to store instructions, modules, or components that can be executed by the processor(s) 604.

Computer-readable media 606 can be used to store and maintain any number of functional components that are executable by the processor(s) 604. In some implementations, these functional components comprise instructions or programs that are executable by the one or more processors and that, when executed, implement operational logic for performing the actions and services attributed above to user device(s) 602. Functional components stored in computer-readable media 606 can include enrollment module 614, payment module 616, user interface module 618 and social network module 620 which can comprise at least a portion of a community payment network application (“payment application”) 612. Enrollment module 614, payment module 616, user interface module 618, social network module 620, and community payment network application 612 (“payment application”) can correspond to enrollment module 516, payment module 514, user interface module 522, and social network module 524 of payment application 512, as described above with reference to FIG. 5.

The term “module” is intended to represent example divisions of the software for purposes of discussion and is not intended to represent any type of requirement or required method, manner or necessary organization. Accordingly, while various “modules” are discussed, their functionality, similar functionality, or both, could be arranged differently (e.g., combined into a fewer number of modules, broken into a larger number of modules, etc.). The modules can include computer instructions/code that can be stored in the computer-readable media 606 and can be executable by processor(s) 604.

The enrollment module 614 can be configured to prompt a user for enrollment information (e.g., name, address, phone, funding source identification, social security number, amount of funds to initially transfer to the financial account, referring user identity, etc.) The enrollment module can transmit enrollment information to the payment service server device(s). The enrollment module 614 can operate together with the user interface module 618 in gathering and transmitting the enrollment information via payment application 612. The enrollment module can communicate with another user device in identifying a referring user. For example, the enrollment module 614 can receive data from a scan by the user device of a QR code or other code from a referring user. The code can be displayed on a user device of the referring user or can be otherwise displayed (e.g., via email, U.S. hard copy mail, a hard copy display at a user's business, etc.). The enrollment module 614 can detect receipt of referring information from a referring user and associate a user's enrollment information with the referring user (by the payment service server device(s) at the time the enrollment information is received, or by the user device before the enrollment information is sent) so that the referring user receives credit for future transactions of the enrolling user.

The payment module 616 can be configured to create or receive transaction data for processing by the payment service. In examples, the transaction data can be manually entered by the user and can include transaction amount, item or service purchased, location, date or time the user wishes the transaction to be processed, etc. In examples, the transaction data can be created at a point-of-sale, either by a user device that is a POS device or that communicates with a POS device. The payment module 616 can be configured to submit the transaction data to the payment service server device(s). In examples, the transaction data may be uploaded but the transaction may not be processed until consent of the other user to the transaction is received via an indication transmitted from the user device of the other user or by a code submitted by the user device that indicates to the payment service that the other user has consented to the transaction.

The user interface module 618 can be configured to cause a user interface to be provided to a user on display(s) 630 of user device(s) 602. In examples, the user interface module 618 can cause a user interface to be provided that allows a user to perform actions associated with payment application 612 or with the community payment network more generally. User interface module 618 of user device(s) 602 can perform actions corresponding to user interface module 522 of the payment service server device(s) 502. In certain instances, user interface module 618 can be configured to provide a user interface corresponding to the user device being used. For example, information can be presented to the user in a different manner when presented on a mobile phone than when presented on a personal computer. In some examples, the user interface can be provided to a user via a web browser (e.g., software as a service (SaaS)), via a downloadable client application, or both.

The social network module 620 can be configured to enable a user to interact regarding transaction activity within the community payment network, in a social forum. For example, the social network module 620 can provide for the participation in one or more social networks with the payment network. A social network can be provided by the social network module 620 such that a user can interact with other users of the payment network. Further, external social networks can be integrated within the payment network via third-party applications, thereby allowing a user of the payment network to engage with users of the external social networks.

Furthermore, computer-readable media 606 can include additional functional components, such as operating system(s) 626 for controlling and managing various functions of user device(s) 602 and for enabling basic user interactions. In addition, computer-readable media 606 can also store data, data structures and the like, that are used by the functional components.

Depending on the type of user device(s) 602, computer-readable media 606 can also optionally include other functional components and data, such as other modules and data 628, which can include programs, drivers, etc., and the data used or generated by the functional components. For instance, computer-readable media 606 of a user device associated with a merchant user can optionally include a point-of-sale (POS) module. Further, user device(s) 602 can include many other logical, programmatic, and physical components, of which those described are merely examples that are related to the discussion herein.

Communication interface(s) 608 can include one or more interfaces and hardware components for enabling communication with various other devices, such as over network(s) or directly. For example, communication interface(s) 608 can enable communication through one or more network, which can include, but are not limited to any type of network known in the art such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. A network can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

User device(s) 602 can further be equipped with various input/output (I/O) device(s) 610. I/O device(s) 510 can be configured to allow a user to interface with the user device(s) 602 via one or more I/O devices. The I/O device(s) 610 can provide an interface for such devices as display(s) 630, audio speakers (not shown), a microphone (not shown), a camera (not shown), connection ports (not shown), an optical reader (not shown), a touchpad (not shown), a haptic output device (not shown), various user interface controls (e.g., buttons, joystick, keyboard, mouse, touch screen, etc.) (not shown), or any combination thereof.

In at least one example, user device(s) 602 can include display(s) 630. Depending on the type of computing device(s) used as user device(s) 602, display(s) 630 can employ any suitable display technology. For example, display(s) 630 can be a liquid crystal display, a plasma display, a light emitting diode display, an OLED (organic light-emitting diode) display, an electronic paper display, or any other suitable type of display able to present digital content thereon. In some examples, display(s) 630 can have a touch sensor associated with display(s) 530 to provide a touchscreen display configured to receive touch inputs for enabling interaction with a graphic interface presented on display(s) 630. Accordingly, implementations herein are not limited to any particular display technology. Alternatively, in some examples, user device(s) 602 may not include display(s) 630, and information can be presented by other means, such as aurally.

In addition, user device(s) 602 can optionally include or can be connectable to card reader(s) 632. In some examples, card reader(s) 632 can plug in to a port in user device(s) 602, such as a microphone/headphone port, a data port, or other suitable port. Card reader(s) 632 can include a read head for reading a magnetic strip of a payment card, and further can include encryption technology for encrypting the information read from the magnetic strip. Alternatively, numerous other types of card readers can be employed with user device(s) 602 herein, depending on the type and configuration of user device(s) 6002.

Other components included in user device(s) 602 can include GPS device(s) 634 that can indicate location information. Further, user device(s) 602 can include one or more sensors 636 such as an accelerometer, gyroscope, compass, proximity sensor, camera, microphone, and/or a switch, as discussed above. Additionally, user device(s) 602 can include various other components that are not shown, examples of which include removable storage, a power source, such as a battery and power control unit, a barcode scanner, a printer, a cash drawer, and so forth.

The present subject matter proposes the integration of at least the aforementioned features into a seamless and convenient mechanism for requesting and receiving manager approvals. With relation to the problems identified previously with conventional systems and methods, the software applications themselves become an active and cooperative component of the process, rather than the subject of it. Further, the aforementioned description is directed to devices and applications that are related to payment technology. However, it will be understood, that the technology can be extended to any device and application. Moreover, techniques described herein can be configured to operate irrespective of the kind of user device, mobile applications, POS topologies, payment service server device, computer networks, and environments. Techniques described herein can be configured to operate in both real-time/online and offline modes.

While the aforementioned disclosure makes reference to user interactions via a UI presented via a display of a device, the UI can be presented via any input/output device. As an example, the UI can be output via a speaker, and augmented reality projector, etc. Further, while the aforementioned disclosure makes reference to a user interacting with the UI via a selectable control, in additional or alternative examples, the user can indicate a selection via a spoken input or other type of input.

The foregoing is merely illustrative of the principles of this disclosure and various modifications can be made by those skilled in the art without departing from the scope of this disclosure. The above described examples are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process limitations (e.g., dimensions, configurations, components, process step order, etc.) can be made to further optimize the provided structures, devices, and methods, as shown and described herein. In any event, the structures, and devices, as well as the associated methods, described herein have many applications. Therefore, the disclosed subject matter should not be limited to any single example described herein, but rather should be construed in breadth and scope in accordance with the appended claims.

Various instructions, methods, and techniques described herein can be considered in the general context of computer-executable instructions, such as program modules stored on computer-readable media, and executed by the processor(s) herein. Generally, program modules include routines, programs, objects, components, data structures, etc., for performing particular tasks or implementing particular abstract data types. These program modules, and the like, can be executed as native code or can be downloaded and executed, such as in a virtual machine or other just-in-time compilation execution environment. Typically, the functionality of the program modules can be combined or distributed as desired in various implementations. An implementation of these modules and techniques can be stored on computer storage media or transmitted across some form of communication media.

### EXAMPLE CLAUSES

Clause 1. A Method Comprising:
receiving, by one or more servers associated with a payment service and from a first computing device associated with a first user of a plurality of users of the payment service, via a first instance of a payment application, enrollment data associated with enrollment of the first user with the payment service;
at least partly in response to receiving the enrollment data, determining, by the one or more servers associated with the payment service, that the first user is eligible to enroll with the payment service;
storing, by the one or more servers associated with the payment service and in a data store associated with the payment service, a user profile associated with the first user;
based at least in part on the enrollment data, identifying, by the one or more servers associated with the payment service, a funding source indicated by the first user;
sending, by the one or more servers associated with the payment service to a device associated with a financial institution, a request on behalf of the first user to open a financial account for the first user at the financial institution;
causing, by the one or more servers associated with the payment service and on a display of the first computing device, presentation of an indication of the financial account and a request for authorization to transfer funds from the funding source to the financial account;
receiving, by the one or more servers associated with the payment service, the authorization;
at least partly in response to receiving the authorization, causing, by the one or more servers associated with the payment service, a transfer of funds from the funding source to the financial account;
receiving, by the one or more servers associated with the payment service and from at least one of the first computing device or a second computing device associated with a second user, first transaction data associated with a first transaction between the first user and the second user, wherein the first user comprises a payor for the first transaction and the second user comprises a payee for the first transaction;
receiving, by the one or more servers associated with the payment service and from at least one of the first computing device or a third computing device of a third user via a respective instance of the payment application executing on the first computing device or the third computing device, second transaction data associated with a second transaction between the first user and the third user, wherein the transaction data includes an indication of the transaction amount, wherein the first user comprises a payor for the second transaction and the third user comprises a payee for the second transaction;
responsive at least in part to receiving the second transaction data associated with the second transaction, determining, by the one or more servers associated with the payment service, a payee fee based at least in part on the second transaction amount and a predetermined calculation;
determining, by the one or more servers associated with the payment service, a first number of credits equivalent to the second transaction amount and a second number of credits equivalent to the payee fee;
causing, by the one or more servers associated with the payment service, transfers of value comprising:
   a transfer of the first number of credits from the user profile associated with the first user to a user profile associated with the third user;
   a transfer of the second number of credits from the user profile associated with the third user to the payment service;
   a transfer of credits equivalent to a first percentage of the payee fee from the payment service to a user profile associated with a referring user based at least in part on determining a referring user associated with the user profile associated with the first user; and
   a transfer of credits equivalent to a second percentage of the payee fee from the payment service to a user profile associated with an immediately previous payee, based at least in part on determining an immediately previous payee based at least in part on the first transaction data, wherein the immediately previous payee comprises the second user.

Clause 2. The method as clause 1 recites, further comprising sending, by the one or more servers associated with the payment service, a transaction record for the second transaction to at least one of the first computing device or the third computing device.

Clause 3. The method as either clause 1 or clause 2 recites, further comprising:
receiving, by the one or more servers associated with the payment service and from the first computing device, a request for a summary of transactions of the first user; and
causing, by the one or more servers associated with the payment service, presentation of the summary of transactions on a display of the first computing device.

Clause 4. The method as any of clauses 1-3 recites, wherein terms of an agreement between the payment service and one or more users of the plurality of users includes a term requiring that the payee fee be less than a minimum threshold payee fee.

Clause 5. The method as any of clauses 1-4 recites, further comprising:
receiving, by the one or more servers associated with the payment service and from the first computing device, a request to convert one or more credits associated with the user profile associated with the first user to a currency of the funding source;
causing, by the one or more servers associated with the payment service, transfer of an amount of currency from the financial institution to the funding source of the first user, wherein the amount of currency comprises a number of the one or more credits multiplied by a ratio of currency units per credit; and
reducing a credit balance associated with the user profile associated with the first user by the one or more credits.

Clause 6. The method as any of clauses 1-5 recites, further comprising:
sending, by the one or more servers associated with the payment service to the first computing device associated with the first user, a request for additional information associated with opening the financial account for the first user at the financial institution; and
receiving, by the one or more servers associated with the payment service and from the first computing device associated with the first user, the additional information,
wherein sending the request on behalf of the first user to open the financial account for the first user at the financial institution is at least partly responsive to receiving the additional information.

Clause 7. The method as any of clauses 1-6 recites, wherein the enrollment data includes at least one of an identifier of the referring user of the first user, an identifier of the funding source, an a funding amount to transfer to the financial institution from the funding source, or personally identifying information.

Clause 8. The method as any of clauses 1-7 recites, wherein the payment application is provided to the first computing device by the one or more servers associated with the payment service.

Clause 9. The method as any of clauses 1-8 recites, wherein determining that the first user is eligible to enroll with the payment service comprises determining that the first user has not previously enrolled with the payment service.

Clause 10. The method as any of clauses 1-9 recites, wherein the funding source comprises a bank, a credit union, a savings and loan association, or a brokerage firm.

Clause 11. A method, implemented by one or more servers of a payment service, the method comprising:
receiving transaction data associated with a transaction between a first user as payor and a second user as payee, wherein the transaction data includes an indication of a transaction amount;
determining a payee fee associated with the transaction, wherein the payee fee is based at least in part on the transaction amount;
determining a first number of credits proportional to the transaction amount and a second number of credits proportional to the payee fee;
transferring the first number of credits or the transaction amount from a user profile associated with the first user to a user profile associated with the second user;
transferring the second number of credits or the payee fee from the user profile associated with the second user to the payment service; and
transferring a third number of credits from the payment service to a user profile associated with a third user, wherein the third user referred the first user to the community payment network, and wherein the third number of credits comprises a first portion of the second number of credits.

Clause 12. The method as clause 11 recites, further comprising:
transferring a fourth number of credits from the payment service to a user profile associated with a fourth user, wherein the first user paid the fourth user in an earlier transaction occurring immediately prior to the transaction, and wherein the fourth number of credits comprises a second portion of the second number of credits.

Clause 13. One or more computer-readable media having computer-readable instructions therein that, when executed by one or more processors, cause the one or more processors to perform a method as either clause 11 or clause 12 recites.

Clause 14. A system comprising:
one or more processors; and
one or more computer-readable media including computer-readable instructions that, when executed by the one or more processors, configure the system to perform a method as either clause 11 or clause 12 recites.

Clause 15. The method as any of clauses 1-10, 11, or 12 recites, wherein the payee fee comprises a flat fee, a percentage of the transaction amount, or a combination of a flat fee and a percentage of the transaction amount.

Clause 16. The method as any of clauses 1-10 or 15 recites, wherein at least one of the payee fee, the first percentage, or the second percentage is a term of an agreement between the payment service and the one or more users.

Clause 17. One or more computer-readable media having computer-readable instructions therein that, when executed by one or more processors, cause the one or more processors to perform a method as any of clauses 1-10, 15, or 16 recite.

Clause 18. A system comprising:
one or more processors; and
one or more computer-readable media including computer-readable instructions that, when executed by the one or more processors, configure the system to perform a method as any of clauses 5-16 recite.

Clause 19. A method comprising:
storing, by the one or more servers associated with the payment service and in a data store associated with the payment service, a user profile associated with a user of a plurality of users of a payment service, wherein the user profile includes information identifying a funding source of the first user;
receiving, by the one or more servers associated with the payment service and from the funding source, an amount of currency;
updating, by the one or more servers of the payment service, the user profile associated with the first user to add a number of credits equivalent to the amount of currency, based at least in part on a ratio of credits to currency;
receiving, by the one or more servers associated with the payment service and from at least one of a first computing device associated with the first user or a second computing device associated with a second user via a respective instance of the payment application executing on the first computing device or the second computing device, transaction data associated with a transaction between the first user and the second user, wherein the transaction data includes an indication of the transaction amount, wherein the first user comprises a payor and the third user comprises a payee in the transaction;
responsive at least in part to receiving the second transaction data associated with the second transaction, determining, by the one or more servers associated with the payment service, a payee fee based at least in part on the second transaction amount and a predetermined calculation;
determining, by the one or more servers associated with the payment service, a first number of credits equivalent to the transaction amount and a second number of credits equivalent to the payee fee;
causing, by the one or more servers associated with the payment service, transfers of value comprising:
   a transfer of the first number of credits from the user profile associated with the first user to a user profile associated with the second user;
   a transfer of the second number of credits from the user profile associated with the second user to the payment service;
   a transfer of credits equivalent to a first percentage of the payee fee from the payment service to a user profile associated with a referring user based at least in part on determining a referring user associated with the user profile of the first user; and
   a transfer of credits equivalent to a second percentage of the payee fee from the payment service to a user profile associated with an immediately previous payee, based at least in part on determining an immediately previous payee based at least in part on the first transaction data, wherein the immediately previous payee comprises the second user.

Clause 20. One or more computer-readable media having computer-readable instructions therein that, when executed by one or more processors, cause the one or more processors to perform a method as clause 19 recites.

Clause 21. A system comprising:
one or more processors; and
one or more computer-readable media including computer-readable instructions that, when executed by the one or more processors, configure the system to perform a method as clause 19 recites.

The invention claimed is:

1. A method comprising:
receiving, by one or more servers associated with a payment service and from a first computing device associated with a first user of a plurality of users of the payment service, via a first instance of a payment application, enrollment data associated with enrollment of the first user with the payment service;
at least partly in response to receiving the enrollment data, determining, by the one or more servers associated with the payment service, that the first user is eligible to enroll with the payment service;
storing, by the one or more servers associated with the payment service and in a data store associated with the payment service, a user profile associated with the first user;
based at least in part on the enrollment data, identifying, by the one or more servers associated with the payment service, a funding source indicated by the first user;
sending, by the one or more servers associated with the payment service to a device associated with a financial institution, a request on behalf of the first user to open a financial account for the first user at the financial institution;
causing, by the one or more servers associated with the payment service and on a display of the first computing device, presentation of an indication of the financial account and a request for authorization to transfer funds from the funding source to the financial account,
receiving, by the one or more servers associated with the payment service, the authorization;
at least partly in response to receiving the authorization, causing, by the one or more servers associated with the payment service, a transfer of funds from the funding source to the financial account;
receiving, by the one or more servers associated with the payment service and from at least one of the first computing device or a second computing device associated with a second user, first transaction data associated with a first transaction between the first user and the second user, wherein the first user comprises a payor for the first transaction and the second user comprises a payee for the first transaction;
receiving, by the one or more servers associated with the payment service and from at least one of the first computing device or a third computing device of a third user via a respective instance of the payment application executing on the first computing device or the third computing device, second transaction data associated with a second transaction between the first user and the third user, wherein the second transaction data includes an indication of a transaction amount associated with the second transaction, wherein the first user comprises a payor for the second transaction and the third user comprises a payee for the second transaction;
responsive at least in part to receiving the second transaction data associated with the second transaction, determining, by the one or more servers associated with the payment service, a payee fee based at least in part on the transaction amount and a predetermined calculation;
determining, by the one or more servers associated with the payment service, a first number of credits equivalent to the transaction amount and a second number of credits equivalent to the payee fee; and
causing, by the one or more servers associated with the payment service, transfers of value comprising:
a transfer of the first number of credits from the user profile associated with the first user to a user profile associated with the third user;
a transfer of the second number of credits from the user profile associated with the third user to the payment service;
a transfer of credits equivalent to a first percentage of the payee fee from the payment service to a user profile associated with a referring user based at least in part on determining that the referring user referred the first user to enroll with the payment service, wherein determining that the referring user referred the first user to enroll is based at least in part on the user profile associated with the first user; and
a transfer of credits equivalent to a second percentage of the payee fee from the payment service to a user profile associated with an immediately previous payee, based at least in part on determining an immediately previous payee based at least in part on the first transaction data, wherein the immediately previous payee comprises the second user.

2. The method as claim 1 recites, further comprising sending, by the one or more servers associated with the payment service, a transaction record for the second transaction to at least one of the first computing device or the third computing device.

3. The method as claim 1 recites, further comprising:
receiving, by the one or more servers associated with the payment service and from the first computing device, a request for a summary of transactions of the first user; and
causing, by the one or more servers associated with the payment service, presentation of the summary of transactions on a display of the first computing device.

4. The method as claim 1 recites, wherein terms of an agreement between the payment service and one or more users of the plurality of users includes a term requiring that the payee fee be less than a minimum threshold payee fee.

5. The method as claim 1 recites, further comprising:
receiving, by the one or more servers associated with the payment service and from the first computing device, a request to convert one or more credits associated with the user profile associated with the first user to a currency of the funding source;
causing, by the one or more servers associated with the payment service, transfer of an amount of currency from the financial institution to the funding source of the first user, wherein the amount of currency comprises a number of the one or more credits multiplied by a ratio of currency units per credit; and
reducing a credit balance associated with the user profile associated with the first user by the one or more credits.

6. The method as claim 1 recites, further comprising:
sending, by the one or more servers associated with the payment service to the first computing device associated with the first user, a request for additional information associated with opening the financial account for the first user at the financial institution; and
receiving, by the one or more servers associated with the payment service and from the first computing device associated with the first user, the additional information,
wherein sending the request on behalf of the first user to open the financial account for the first user at the financial institution is at least partly responsive to receiving the additional information.

7. The method as claim 1 recites, wherein the enrollment data includes at least one of an identifier of the referring user of the first user, an identifier of the funding source, a funding amount to transfer to the financial institution from the funding source, or personally identifying information.

8. The method as claim 1 recites, wherein the payment application is provided to the first computing device by the one or more servers associated with the payment service.

9. The method as claim 1 recites, wherein determining that the first user is eligible to enroll with the payment service comprises determining that the first user has not previously enrolled with the payment service.

10. The method as claim 1 recites, wherein the funding source comprises a bank, a credit union, a savings and loan association, or a brokerage firm.

11. A method, implemented by one or more servers of a payment service associated with a community payment network, the method comprising:
receiving transaction data associated with a transaction between a first user as payor and a second user as payee, wherein the transaction data includes an indication of a transaction amount;
determining a payee fee associated with the transaction, wherein the payee fee is based at least in part on the transaction amount;
determining a first number of credits proportional to the transaction amount and a second number of credits proportional to the payee fee;
transferring the first number of credits or the transaction amount from a user profile associated with the first user to a user profile associated with the second user;
transferring the second number of credits or the payee fee from the user profile associated with the second user to the payment service; and
transferring a third number of credits from the payment service to a user profile associated with a third user, wherein the third user referred the first user to the community payment network, and wherein the third number of credits comprises a first portion of the second number of credits.

12. The method as claim 11 recites, further comprising:
transferring a fourth number of credits from the payment service to a user profile associated with a fourth user, wherein the first user paid the fourth user in an earlier transaction occurring immediately prior to the transaction, and wherein the fourth number of credits comprises a second portion of the second number of credits.

13. (canceled)

14. (canceled)

15. The method as claim 1 recites, wherein the payee fee comprises a flat fee, a percentage of the transaction amount, or a combination of a flat fee and a percentage of the transaction amount.

16. The method as claim 1 recites, wherein at least one of the payee fee, the first percentage, or the second percentage is a term of an agreement between the payment service and one or more users of the plurality of users.

17. (canceled)

18. (canceled)

19. One or more non-transitory computer-readable media storing instructions executable by one or more processors that, when executed by the one or more processors, cause the one or more processors to perform acts comprising:
storing, in a data store associated with a payment service, a user profile associated with a first user of a plurality of users of a payment service, wherein the user profile includes information identifying a funding source of the first user;
receiving, and from the funding source, an amount of currency;
updating the user profile associated with the first user to add a number of credits equivalent to the amount of currency, based at least in part on a ratio of credits to currency;
receiving, and from at least one of a first computing device associated with the first user or a second computing device associated with a second user via a respective instance of a payment application executing on the first computing device or the second computing device, transaction data associated with a transaction between the first user and the second user, wherein the transaction data includes an indication of a transaction amount associated with the transaction, wherein the first user comprises a payor and the second user comprises a payee in the transaction;
responsive at least in part to receiving the transaction data associated with the transaction, determining a payee fee based at least in part on the transaction amount and a predetermined calculation;
determining a first number of credits equivalent to the transaction amount and a second number of credits equivalent to the payee fee; and
causing transfers of value comprising:
a transfer of the first number of credits from the user profile associated with the first user to a user profile associated with the second user;
a transfer of the second number of credits from the user profile associated with the second user to the payment service;
a transfer of credits equivalent to a first percentage of the payee fee from the payment service to a user profile associated with a referring user, based at least in part on determining a referring user associated with the user profile of the first user; and
a transfer of credits equivalent to a second percentage of the payee fee from the payment service to a user profile associated with an immediately previous payee, based at least in part on determining an immediately previous payee based at least in part on the first transaction data, wherein the immediately previous payee comprises the second user.

20. (canceled)

21. (canceled)

22. The method as claim 1 recites, wherein the transfers of value further comprise a transfer of credits equivalent to a third percentage of the payee fee from the payment service to a fourth user.

23. The method as claim 1 recites, wherein the transfers of value further comprise a transfer of a third percentage of the payee fee to an entity, wherein the entity comprises at least one of the financial institution, another financial institution a non-profit organization, a charitable organization, an individual, a small business, or a government entity.

24. (canceled)

25. The method as claim 1 recites, wherein the enrollment data includes an identifier of the referring user, and wherein the identifier comprises a QR code or URL associated with the referring user.

26. The one or more non-transitory computer-readable media of claim 19, the acts further comprising:
sending a transaction record for the transaction to at least one of the first computing device or the second computing device.

27. The one or more non-transitory computer-readable media of claim 19, wherein the payment application is provided to the first computing device by the payment service.
